(19) United States
(12) Patent Application Publication
(10) Pub. No.: US 2005/0271234 A1
(43) Pub. Date: Dec. 8, 2005

(54) Headset having an attachment element for attaching an ear hook to a holding ring

(75) Inventor: Tom Bogeskov-Jensen, Slangerup (DK)

Correspondence Address: ALTERA LAW GROUP, LLC, 6500 CITY WEST PARKWAY, SUITE 100, MINNEAPOLIS, MN, 55344-7704, US

(73) Assignee: GN Netcom A/S, Ballerup (DK)

(21) Appl. No.: 11/131,545

(22) Filed: May 18, 2005

(30) Foreign Application Priority Data
Nov. 27, 2002 (DK) PA 2002 01830
Nov. 26, 2003 (WO) PCT/DK03/00808

(51) Int. Cl. H04R 25/00

(52) U.S. Cl. 381/381

(57) ABSTRACT

A headset which consists of an ear hook and a holding ring that are interconnected by means of an attachment element formed by a hinge, which is made of a deformable, flexible material that may be an elastomer, such as EPOM, TPE or Santroprene®The hinge has a four-sided hole in which one end of the ear hook may be received, said end being formed with a four-sided shape in dimensions corresponding to the hole. Teeth are formed in the hole which are capable of cooperating with depressions formed on the four-sided end. The invention provides an attachment element which may be manipulated several times when adjusting the position of the ear hook relative to the holding ring, without play occurring in the hinge at any time, since there are no mutually movable slide bearing parts, such as shafts that can slide. In other words, a stable attachment is ensured between the ear hook and the holding ring in the positions selected by a user. In addition, it is possible to displace the ear hook in the hinge by mutual displacement of the positions in which the teeth engage the depressions.

### RELATED APPLICATION

The present application is a continuation-in-part of international application PCT/DK2003/000808 filed on 26 Nov. 2003, entitled A HEADSET HAVING AN ATTACHMENT ELEMENT FOR ATTACHING AN EAR HOOK TO A HOLDING RING, claiming priority from Danish PA 2002 01830 filed on 27 Nov. 2002.

### BACKGROUND OF THE INVENTION

### FIELD OF THE INVENTION

The invention relates to a headset having an attachment element for attaching an ear hook to a holding ring, said attachment element being formed by a hinge which is made of a deformable, flexible material.

Such a headset is known e.g. from EP 1 003 349 A2. This document describes an attachment element in which a holding ring is attached to an ear hook by means of a rotatable element. The rotatable element consists of a pin which is provided on the holding ring, and on whose surface a flange is arranged, said flange being capable of cooperating with a cylindrical hole which is formed in the ear hook, and which internally has a slit. When the pin is inserted into the hole, the flange engages with the slit, thereby allowing rotation of the ear hook relative to the holding ring. In contrast, it is not possible to effect any axial displacement of the pin in the hole.

The rotation takes place with a certain friction, so that the ear hook may be positioned at a desired angle relative to the holding ring.

This structure operates well, but after use for an extended period of time there is a certain risk that the friction between the pin and the hole diminishes, which means that the ear hook cannot be retained completely in the desired position, which means in turn that the holding ring rotates when the ear hook is positioned on the ear. In addition, there is a risk that “play” occurs in the rotatable element.

Accordingly, an object of the invention is to produce a headset having an attachment element which maintains the desired properties also after use for an extended period of time, and which is moreover composed of fewer parts.

A further object is to provide a headset having user-friendly adjustment possibilities.

The object of the invention is achieved by a headset, which is characterized in that the ear hook is axially displaceable and fixable in different positions in the attachment element, attachment element is formed by a hinge which is made of a deformable, flexible material. The object is achieved in this manner, as commercially available deformable, plastics materials maintain their properties, also after use for an extended period of time.

Expediently, the flexible material is an elastomer, such as TPE (Polyester Thermoplastic Elastomer), Santroprene®, Temprene, EPOM (Engineering Polymer Oil Modified), TPU (Polyurethane Thermoplastic Elastomer) or the like, thereby providing a number of options for the selection of a suitable composition of materials that optimizes the properties of the hinge according to the requirements made with respect to manufacture, external appearance of the hinge, user need, environment, bonding to other materials, etc.

For use in the adaptation of the ear hook to the needs of the individual user, it is an advantage if, the ear hook is axially displaceable in the attachment element, as the holding ring with a mounted speaker may hereby be positioned exactly at the entry to the user's ear.

This adaptation may be established in a simple manner when, the axial displacement is established in that one end of the ear hook is formed with teeth or depressions which cooperate with teeth or depressions provided in a hole in the attachment element.

Further to ensure that the ear hook is not twisted, it is an advantage if, that one end of the ear hook is formed with a four-sided shape, and that the hole of the attachment element is four-sided.

With a view to allowing selection between several types of materials in the production of the headset, it is advantageous if, the attachment element is mounted on a ring of the same material as the attachment element, and that the ring is formed as a holder for the holding ring.

To stiffen the entire headset, it is expedient if, the holding ring is made of a hard, plastics material.

If, the ear hook is made of a hard and soft plastics material, it is ensured that the ear hook may be bent and thereby be adapted when being arranged around a user's ear.

Finally, the end of the ear hook which is inserted into the hole of the attachment element may be made of a hard, plastics material, which ensures a firm attachment between the ear hook and the attachment element.

The invention will now be explained more fully with reference to the embodiment of the invention shown in the drawing, in which

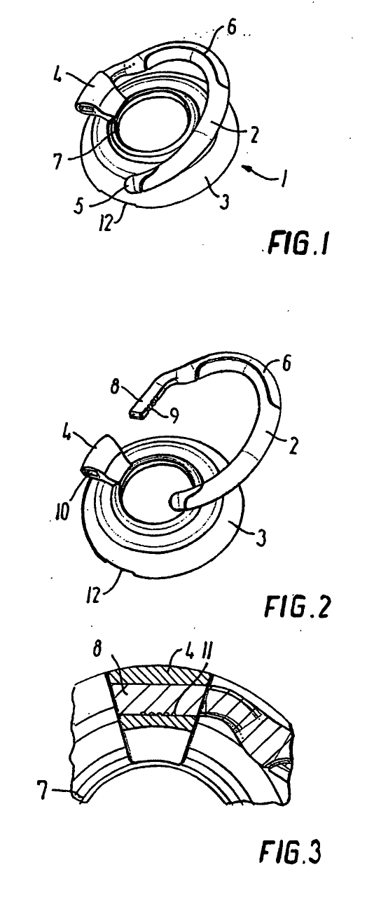

FIG. 1 shows a headset having an ear hook, a holding ring and an attachment element according to the invention,

FIG. 2 shows the headset of FIG. 1, but with the ear hook separated from the attachment element, while

FIG. 3 shows, partly in section, how the ear hook is attached to the attachment element.

In the figures, 1 designates a headset which has an ear hook 2 connected to a holding ring 3 by means of an attachment element 4. This attachment element may be moulded on a ring 7 of the same material as the attachment element. This ring is dimensioned to receive the holding ring.

Alternatively, by suitable selection of materials, the attachment element may be moulded directly on the holding ring 3.

In the holding ring there may be mounted a speaker, electrical circuits, adjustment buttons, light-emitting diodes and the like (not shown), which may be constructed as a compact unit that may be snap-coupled to the holding ring. For the purpose of connecting a charging device, the holding ring 3 is formed with a recess 12 in which a plug for the charging device may be connected.

A portion of the ear hook is made of a soft material, while another portion is made of a hard material, as shown at 5 and 6, which means that the ear hook both has a suitable rigidity, but also that it may be bent with a view to being adapted to a user's ear.

As will be seen in the figures, the hard material is located at both ends of the ear hook, while the soft material, which may enclose a piece of steel wire, is positioned between the ends. It is hereby possible to shape the soft member by bending and thereby adapt the ear hook to a user's ear anatomy.

As will be seen in FIG. 2, one end of the ear hook is terminated with a four-sided member 8, which is in turn formed with depressions or teeth 9. Of course it anticipated that member 4 need not be 4-sided. It may have N-sides, or no sides at all, as in an oval or other shape. The key requirement is that element 8 need not rotate in hole 10. The bending movement is accorded elsewhere, namely in the attachment 4. This four-sided member 8 may be inserted into a hole 10 which is formed in the attachment element 4, said hole being likewise four-sided and formed with teeth 11 (see FIG. 3) and/or depressions on its inner side surface. Again, the depressions or teeth 11 are only one of many ways to accomplish the goal of adjustably maintaining member 8 into receiver hole 10. A friction fit might be suitable as well as would other detents and depressions. The objective is to provide slideability of member 8 with the ability of fix at any depth the penetration of member 8 into hole 10 so that the user has complete adjustability (vertical displacement) of that aspect of the earhook. This structure allows adjustment of the spacing between the inner side of the ear hook and the position of the holding ring, thereby allowing the entire headset to be adjusted so that the holding ring is centered at the entry of a user's ear.

The attachment element 4 itself is preferably made of a deformable, flexible, elastomeric material, such as TPE (Polyester Thermoplastic Elastomer), Santroprene®, Temprene, EPOM (Engineering Polymer Oil Modified), TPU (Polyurethane Thermoplastic Elastomer) or the like but the important feature is that it may be flexible and deformable regardless of the material. With this feature, it is possible to bend and twist the earhook 2 at many angles and positions to accommodate different ear sizes. The combination of flexibility of the attachment element 4 and portions of earhook 2, provide for a myriad of ways the device can be shaped to accommodate various uses.

These materials inter alia have the property that they are permanently deformable. In other words, they have properties which correspond to a hinge that may be disposed in various positions.

In the same manner, the attachment element 4 may be manipulated to and fro relative to the holding ring 3 by applying a force to the holding ring, or typically by applying a force to the ear hook 2. All things considered, a user thus has the possibility of adjusting the ear hook by vertical displacement of the ear hook into and out of the attachment element, or by rotation of the ear hook in a horizontal plane to and from the holding ring by virtue of the flexible section of the ear hook extending from the rigid section 8 or by making the attachment member 4 deformable or both.

Since, as mentioned, the attachment element is formed as a hinge in a permanently deformable, elastic material, it will remain its rigidity even when subjected to many impacts over an extended period of time, so that the ear hook does not risk being so loosely attached to the hinge that it can rotate almost without any application of force.

1. A headset having an attachment element for attaching an ear hook to a holding ring, said attachment element being formed by a hinge which is made of a deformable, flexible material, wherein the ear hook is axially displaceable and fixable in different positions in the attachment element.

2. A headset according to claim 1, wherein the flexible material is an elastomer.

3. A headset according to claim 2, wherein the elastomer consists of TPE (Polyester Thermoplastic Elastomer), Santroprene®, Temprene, EPOM (Engineering Polymer Oil Modified), TPU (Polyurethane Thermoplastic Elastomer) or the like.

4. A headset according to claim 1, wherein the axial displacement is established in that one end of the ear hook is formed with teeth or depressions which cooperate with teeth or depressions provided in a hole in the attachment element.

5. A headset according to claim 1, wherein one end of the ear hook is formed with a four-sided shape, and that the hole of the attachment element is four-sided.

6. A headset according to claim 1, wherein the attachment element is mounted on a ring of the same material as the attachment element, and that the ring is formed as a holder for the holding ring.

7. A headset according to claim 1, wherein the holding ring is made of a hard, plastics material.

8. A headset according to claim 1, wherein the ear hook is made of a hard and soft plastics material.

9. A headset according to claim 1, wherein the end of the ear hook which is inserted into the hole of the attachment element is made of a hard plastics material.
